(19) United States
(12) Patent Application Publication
(10) Pub. No.: US 2012/0212986 A1
(43) Pub. Date: Aug. 23, 2012

(54) SWITCHING POWER SUPPLY APPARATUS

(75) Inventors: Eiji MINAMI, NAGANO (JP); Takashi KAWAI, NAGANO (JP)

(73) Assignee: MINEBEA CO., LTD., KITASAKU-GUN (JP)

(21) Appl. No.: 13/396,788

(22) Filed: Feb. 15, 2012

(30) Foreign Application Priority Data
Feb. 22, 2011 (JP) 2011-036264

(51) Int. Cl. H02M 7/06

(52) U.S. Cl. 363/126

(57) ABSTRACT

A switching power supply apparatus includes: an input part; an input filter provided for a power factor correction circuit, which includes at least a line capacitor; a bridgeless power factor correction circuit that is connected to the input part; and an inrush current suppression circuit to suppress inrush current, wherein the bridgeless power factor correction circuit comprises: a conversion unit, which has a boost inductor unit and a switching circuit connected to the boost inductor unit; and a smoothing unit that is connected to an output terminal side of the conversion unit, and wherein the inrush current suppression circuit is arranged at least one of: a path connecting between an end of the input filter and the boost inductor unit; a path connecting between the boost inductor unit and the switching circuit; and a path connecting between the switching circuit and the smoothing unit.

### CROSS-REFERENCE TO RELATED APPLICATION

This application claims priority from Japanese Patent Application No. 2011-036264 filed on Feb. 22, 2011, the entire subject matter of which is incorporated herein by reference.

### TECHNICAL FIELD

This disclosure relates to a switching power supply apparatus, and more specifically, to a switching power supply apparatus that converts alternating current power into direct current power by a bridgeless power factor correction circuit.

### BACKGROUND

As a power supply apparatus used for an electronic device and the like, it is known that, for example, a switching power supply apparatus, which has an AC-DC converter, which is connected to a commercial alternating current power supply, and which converts alternating current power into direct current power and enables the direct current power to be used.

Such switching power supply apparatus is provided with a rectification circuit that converts an alternating current voltage into a direct current voltage and a smoothing capacitor. The smoothing capacitor is arranged between a high voltage side line (path) and a low voltage side line of output terminals of the rectification circuit. The smoothing capacitor smoothes a ripple voltage to a constant voltage, charges the electrical charges and discharges the electrical charges to a load circuit and the like connected to the switching power supply apparatus.

Meanwhile, in the switching power supply apparatus simply having the smoothing capacitor, when a supply of the alternating current voltage starts, high inrush current transitionally flows due to supply the electrical charges to the smoothing capacitor, so that a circuit device may be damaged due to the inrush current. In order to solve the problem, an inrush current suppression circuit is provided on a path along which the inrush current flows.

Also, the switching power supply apparatus that converts the alternating current power into the direct current power is provided with a power factor correction circuit for improving a power factor.

An input filter provided for the power factor correction circuit is provided on a path closer to an input part than the power factor correction circuit in order to suppress the ripple to be leaked to the alternating current power supply.

FIG. 6 is a circuit diagram illustrating an example of a switching power supply apparatus according to the related art.

As shown in FIG. 6, a switching power supply apparatus 81 has an input part 801a that is connected to an alternating current power supply 801, an inrush current suppression circuit 803, a rectification circuit 810 using a bridge diode, an input filter 802 for a power factor correction circuit, a power factor correction circuit 811 and a main converter 808. The inrush current suppression circuit 803 is arranged at one of two power feed lines that connect the input part 801 and the rectification circuit 810. The input filter 802 has a line capacitor C1 that is connected to output lines of the rectification circuit 810 in parallel with the rectification circuit 810. The input filter 802 is provided in order to suppress the ripple from the power factor correction circuit 811 from being leaked to the alternating current power supply 801. The power factor correction circuit 811 has a coil L3, a diode D4, a switching device Q3 and a smoothing capacitor C2. The direct current power that is output from the power factor correction circuit 811 is fed to a load circuit 809 via the main converter 808. In the meantime, although not shown, a noise filter such as Electro Magnetic Interference (EMI) filter may be provided on a path between the input part 801a and the inrush current suppression circuit 803 in order to suppress a noise from being leaked or introduced through a wiring, taking into consideration design conditions and the like of the switching power supply apparatus 81.

Also, it is known that a switching power supply apparatus which does not use a bridge diode, i.e., a bridgeless power factor correction circuit. The switching power supply apparatus having the bridgeless power factor correction circuit has excellent properties regarding power conversion efficiency and the like. That is, for example, in the rectification circuit 810 using a bridge diode, which is used in the switching power supply apparatus 81 shown in FIG. 6, power loss corresponding to a voltage drop of the diode occurs. However, the bridgeless power factor correction circuit may improve the power conversion efficiency as much.

JP-A-2010-154582 discloses a switching power supply apparatus that converts and outputs alternating current power into direct current power. The switching power supply apparatus has a switching circuit including two sets of a boost inductor connected to one terminal of an alternating current power supply, a diode and a switching device. The switching power supply apparatus has an auxiliary circuit so that switching efficiency is improved by zero voltage switching.

JP-A-2007-527687 discloses a switching power supply apparatus that converts and outputs alternating current power into direct current power. The switching power supply apparatus has a switching circuit including two sets of a boost inductor connected to one terminal of an alternating current power supply, a diode and a switching device. The switching power supply apparatus also has a smoothing capacitor at an output terminal side of a power factor correction circuit.

### SUMMARY

However, reactive power may occur in a path including an inrush current suppression circuit and a line capacitor configuring an input filter provided for a power factor correction circuit, according to a position of the inrush current suppression circuit in the circuit of the switching power supply apparatus. When the reactive power occurs, power is consumed in the inrush current suppression circuit, so that power loss occurs. The power loss is a factor of increasing standby power consumption in an electronic device and the like. It is required to reduce the standby power consumption in the electronic device and the like, and it is required to suppress the power loss. In the below, the reactive power and the power loss due to the reactive power are described.

The reactive power can be calculated by a following equation. Here, Ic is reactive power, ω is an angular frequency of an alternating current power supply, C is an interpolar capacity value of an alternating current circuit and Vac is an alternating current input voltage.

Ic=ωCVac

The input filter provided for a power factor correction circuit is provided on a path closer to the input part than the power factor correction circuit, as described above. In general, the input filter includes a line capacitor having a larger capacity value than a line capacitor that is used in a noise filter that may be arranged at the input part of the alternating current power.

For a case where the power factor correction circuit is used together with the rectification circuit using a so-called bridge diode, the line capacitor of the input filter is arranged between the rectification circuit and the power factor correction circuit. Accordingly, the reactive power does not flow. For example, for the switching power supply apparatus 81 shown in FIG. 6, the input filter 802 of the power factor correction circuit 811 is arranged at an input terminal side of the power factor correction circuit 811, i.e., on a path connecting the rectification circuit 810 and the power factor correction circuit 811, i.e., at the direct current circuit side. In this case, the reactive power does not flow in the inrush current suppression circuit 803 arranged at the position closer to the alternating current power supply 801 than the rectification circuit 810 and in the input filter 802 itself. Accordingly, in this case, the power loss due to the reactive power is not caused.

Also, although not shown, the switching power supply apparatus 81 may be provided at the alternating current circuit side with a noise filter such as EMI filter. However, the noise filter is not particularly problematic. That is, in general, a line capacitor that is used in a noise filter has a relatively small capacity value to a capacity value of the line capacitor that is used in the input filter 802. Therefore, even when the inrush current suppression circuit 803 is arranged on a path connecting one terminal of the input part 801a and the noise filter, the occurred reactive power and the power loss, which is caused as the reactive power flows through the inrush current suppression circuit 803, are not particularly problematic.

However, the power loss due to the reactive power may be problematic in a switching power supply apparatus having a bridgeless power factor correction circuit. That is, since the bridge diode is not used in the bridgeless power factor correction circuit, the input filter provided for the power factor correction circuit is arranged at the alternating current circuit side. Accordingly, the reactive power passing through the inrush current suppression circuit may flow through the line capacitor of the input filter, so that the power loss may occur.

FIG. 7 illustrates another example of a switching power supply apparatus according to the related art.

In the switching power supply apparatus 82 shown in FIG. 7, the power factor correction circuit 811 and the bridge diode 810 for rectification as the switching power supply apparatus 81 shown in FIG. 6 are replaced with a bridgeless power factor correction circuit 804. For explanations, FIG. 7 illustrates that a resistance R1 is used as the inrush current suppression circuit 803.

As shown in FIG. 7, in the switching power supply apparatus 82, an input filter 802 for the bridgeless power factor correction circuit 804 is arranged at a position closer to an alternating current power supply 801 than the bridgeless power factor correction circuit 804 and more distant from the alternating current power supply 801 than an inrush current suppression circuit 803. The input filter 802 is connected between two lines connected to the alternating current power supply 801 in parallel with the alternating current power supply 801. Therefore, a path of reactive current Ic (refer to a dotted-dashed line arrow in FIG. 7) is formed in an alternating current circuit including the inrush current suppression circuit 803 and the input filter 802.

At this time, for example, with respect to the resistance R1, a line capacitor C1 and the alternating current power supply 801, when R1=15[Ω], C1=2.2[μF], Vac=100[V] and a frequency=50[Hz], the reactive power Ic is as follows.

Ic=ωCVac=2π×50[Hz]×2.2[μF]×100[V]≈69[mA]

Therefore, the power loss P due to the consumption in the inrush current suppression circuit 803 is as follows.

P=Ic²R=69[mA]×69[mA]×15[Ω]≈71[mW]

The value of 71[mW] is a large value, in view of the standby power consumption in an electronic device.

Like this, when the switching power supply apparatus 82 adopts the bridgeless power factor correction circuit, while it is possible to improve the power conversion efficiency when the apparatus is operating, the power loss due to the reactive power is increased. Also, since the power loss due to the reactive power occurs not only during the operation of the power supply apparatus but also during the standby of the power supply apparatus, the standby power consumption of the switching power supply apparatus 82 is increased.

An effective solution to the problem of the power loss is not disclosed in JP-A-2010-154582 and JP-A-2007-527687.

In view of the above, this disclosure provides a switching power supply apparatus having a power factor correction circuit in which a suppression of inrush current is prepared and power loss due to the inrush current is suppressed.

A switching power supply apparatus of this disclosure comprises: an input part, which is configured to connect to an alternating current power supply; an input filter provided for a power factor correction circuit, which includes at least a line capacitor connected to the input part in parallel with the alternating current power supply; a bridgeless power factor correction circuit that is connected to the input part at a position more distant from the alternating current power supply than the input filter; and an inrush current suppression circuit to suppress inrush current, wherein the bridgeless power factor correction circuit comprises: a conversion unit, which has a boost inductor unit to which alternating current from the input part is input and a switching circuit connected to the boost inductor unit, which rectifies an alternating current voltage input from the alternating current power supply and performs a power factor improvement operation, and which outputs a boosted ripple voltage; and a smoothing unit that is connected to an output terminal side of the conversion unit and smoothes the ripple voltage output from the conversion unit, and wherein the inrush current suppression circuit is arranged at least one of: a path connecting between an end of the input filter and the boost inductor unit; a path connecting between the boost inductor unit and the switching circuit; and a path connecting between the switching circuit and the smoothing unit.

In the above-described switching power supply apparatus, the inrush current suppression circuit may be arranged on the path connecting an end of the input filter and the boost inductor unit, the switching circuit may comprises: a first series circuit including a first switching device and a first rectification device connected to an output terminal of the first switching device, and a second series circuit including a second switching device and a second rectification device connected to an output terminal of the second switching device, wherein the second series circuit is connected in parallel with the first series circuit, wherein the smoothing unit has a smoothing capacitor that is connected to an output terminal of the switching circuit in parallel with the switching circuit, and wherein the boost inductor unit comprises: a first inductor, of which one end is connected to a connection point of the first switching device and the first rectification device and the other end connected to the inrush current suppression circuit, and a second inductor, of which one end is connected to a connection point of the second switching device and the second rectification device and the other end connected to the input part.

According to this disclosure, the inrush current suppression circuit is provided on at least one of the path connecting the end of the input filter and the boost inductor unit, the path connecting the boost inductor unit and the switching circuit and the path connecting the switching circuit and the smoothing unit. Therefore, it is possible to provide a switching power supply apparatus having a power factor correction circuit in which a suppression of inrush current is prepared and power loss due to the inrush current is suppressed.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a circuit diagram illustrating an example of a configuration of a switching power supply apparatus according to an illustrative embodiment of this disclosure.

FIG. 2 is a circuit diagram illustrating a detailed configuration of the switching power supply apparatus;

FIG. 3 illustrates an example of a configuration of an inrush current suppression circuit;

FIG. 4 is a circuit diagram illustrating a modified embodiment of the illustrative embodiment;

FIG. 5 illustrates an example of a configuration of an input filter provided for a power factor correction circuit;

FIG. 6 is a circuit diagram illustrating an example of a switching power supply apparatus according to the related art; and

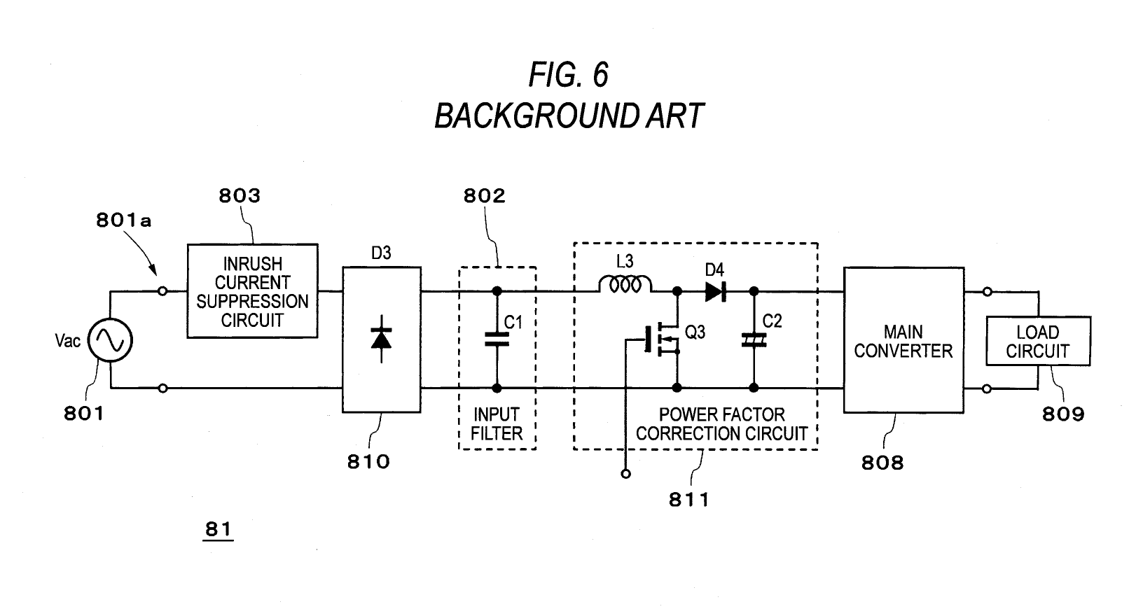

FIG. 7 is a circuit diagram illustrating another example of a switching power supply apparatus according to the related art.

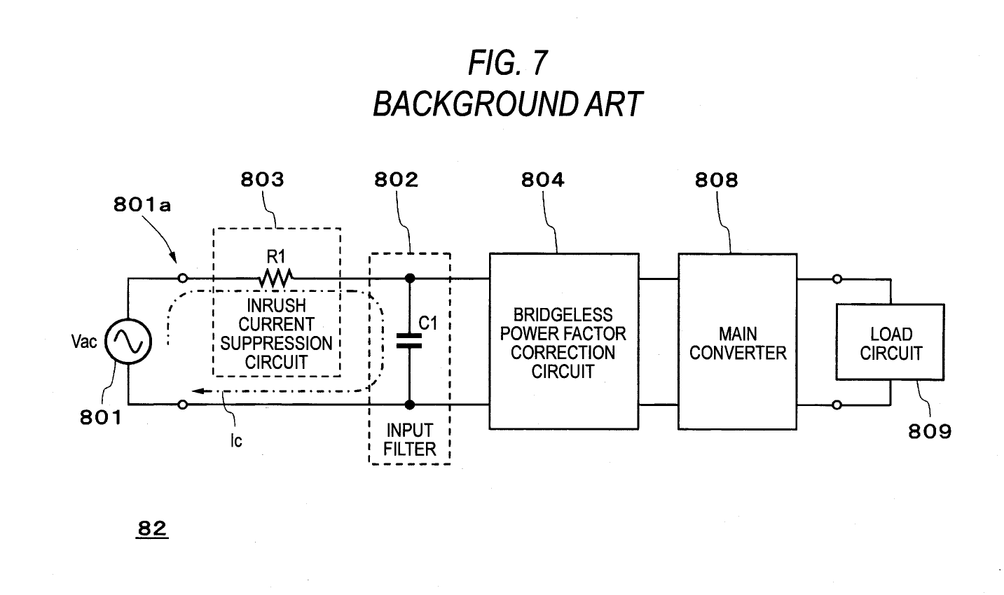

### DETAILED DESCRIPTION

Hereinafter, a switching power supply apparatus according to an illustrative embodiment of this disclosure will be described with reference to the drawings.

### Illustrative Embodiments

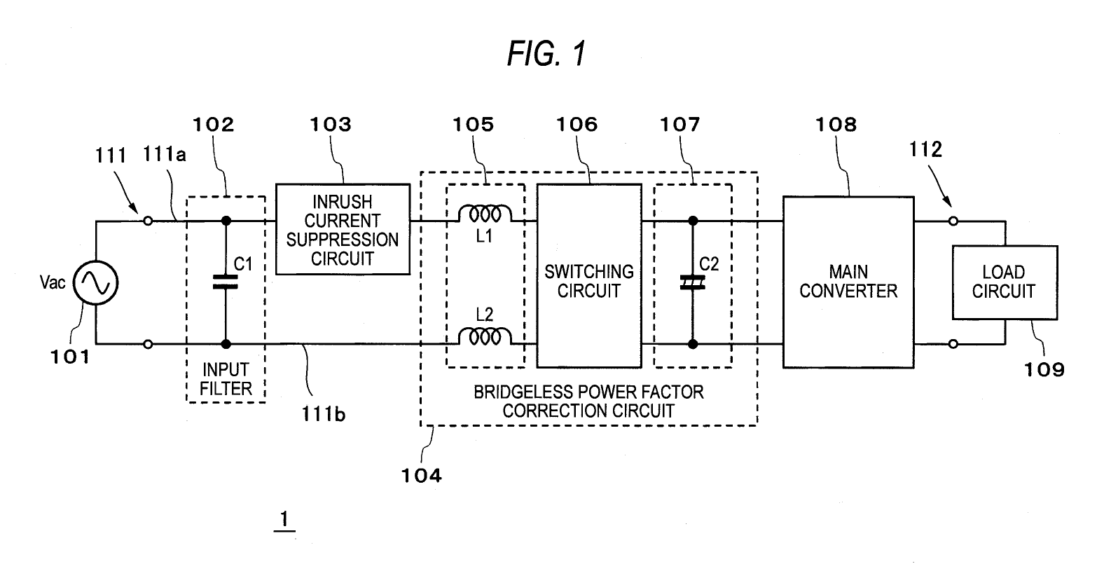

FIG. 1 is a circuit diagram illustrating an example of a configuration of a switching power supply apparatus according to an illustrative embodiment of this disclosure.

A switching power supply apparatus 1 is an AC-DC converter. As shown in FIG. 1, the switching power supply apparatus 1 has an input terminal (which is an example of an input part configured to connect to an alternating current power supply) 111, an input filter 102 for a power factor correction circuit, an inrush current suppression circuit 103, a bridgeless power factor correction circuit (which is an example of a power factor correction circuit) 104, a main converter 108 and an output terminal 112 that outputs power from the main converter 108. The switching power supply apparatus 1 is connected to an alternating current power supply 101 at the input terminal 111. The switching power supply apparatus 1 outputs direct current power from the bridgeless power factor correction circuit 104, based on an alternating current voltage Vac that is input from the alternating current power supply 101 through the input terminal 111. The switching power supply apparatus 1 feeds the direct current power to a load circuit 109 connected to the output terminal 112, through the main converter 108. In the meantime, although not shown, a noise filter such as EMI filter may be used to suppress a noise from being leaked or introduced through a wiring, taking into consideration design conditions and the like of the switching power supply apparatus 1. However, the noise filter should be distinguished from the input filter 102 described in the illustrative embodiment of this disclosure because they are different from each other in terms of purposes and effects.

The alternating current power supply 101 is a commercial alternating current power supply, for example. The alternating current power supply 101 is configured so that it may be used via a plug socket, for example. The alternating current power supply 102 has two output terminals.

The input terminal 111 may be a commercial alternating current input terminal and is a plug that may be inserted into a plug socket, for example. The input terminal 111 is connected to the two output terminals of the alternating current power supply 101 with being inserted into the plug socket of the alternating current power supply 101. Thereby, an alternating current voltage Vac is applied to the switching power supply apparatus 1 from the alternating current power supply 101 (alternating current power is fed). The alternating current voltage is input between a first line 111a and a second line 111b connecting from the input terminal 111 to the bridgeless power factor correction circuit 104, respectively.

In the meantime, a combination of the input terminal 111 and the alternating current power supply 101 is not limited to the plug and the plug socket. For example, the input terminal 111 may be configured by a power supply switch and the switching power supply apparatus 1 may be connected to the alternating current power supply 101 all the time. In this case, the feeding of the alternating current power to the switching power supply apparatus 1 may be on or off in the input terminal 111.

The input filter 102 is arranged at a front stage of the bridgeless power factor correction circuit 104, i.e., at a position closer to the alternating current power supply 101 than the bridgeless power factor correction circuit 104. The input filter 102 has a line capacitor C1.

The line capacitor C1 is connected to both ends of the input terminal 111 in parallel with the alternating current power supply 101. That is, the line capacitor C1 is connected between the first line 111a and the second line 111b. The line capacitor C1 suppresses ripple from the bridgeless power factor correction circuit 104 from being leaked to the alternating current power supply 101.

In the meantime, the input filter 102 may have another circuit device, in addition to the line capacitor C1 or instead of the line capacitor C1.

The bridgeless power factor correction circuit 104 is connected to the input terminal 111 through the first line 111a and the second line 111b so that it is more distant from the alternating current power supply 101 than the line capacitor C1.

The bridgeless power factor correction circuit 104 has a boost inductor unit 105, a switching circuit 106 and a smoothing unit 107. The boost inductor unit 105 and the switching circuit 106 serve as a conversion unit of rectifying the alternating current voltage input from the alternating current power supply 101, performing a power factor improvement operation, and outputting a boosted ripple voltage. That is, the boost inductor unit 105 and the switching circuit 106 configure a conversion unit having a boosting function and a function of rectifying alternating current. The smoothing unit 107 smoothes the ripple voltage output from the conversion unit. The direct current power smoothed by the smoothing unit 107 is output from the bridgeless power factor correction circuit 104.

The alternating current is input from the input terminal 111 to the boost inductor unit 105 through the first line 111a and the second line 11b. The boost inductor unit 105 includes a first inductor L1 connected to the first line 111a and a second inductor L2 connected to the second line 111b. In this illustrative embodiment, the first inductor L1 and the second inductor L2 are used as boost inductors.

The switching circuit 106 includes a diode, a switching device and the like. The switching circuit 106 is connected to the boost inductor unit 105. The detailed configuration of the switching circuit 106 will be described in the below.

The smoothing unit 107 has a smoothing capacitor C2. The smoothing capacitor C2 is connected between a high voltage side output terminal and a low voltage side output terminal, which are output terminals of the switching circuit 106, in parallel with the switching circuit 106. In other words, the smoothing capacitor C2 is connected between a high voltage side output terminal and a low voltage side output terminal of the bridgeless power factor correction circuit 104. The smoothing capacitor C2 smoothes the ripple voltage, which is output from the switching circuit 106, to a constant voltage, charges the electrical charges and discharges the electrical charges to the load circuit 109 through the main converter 108.

In the meantime, an electrolytic capacitor and the like is used as the smoothing capacitor C2. However, this disclosure is not limited thereto.

In this illustrative embodiment, the inrush current suppression circuit 103 is arranged on one path of two paths connecting between ends of the line capacitor C1 and the boost inductor unit 105, which is an input terminal of the bridgeless power factor correction circuit 104, i.e., on the first line 111a. When the supply of the alternating current voltage Vac from the alternating current power supply 101 starts, for example, the inrush current suppression circuit 103 suppresses the inrush current that flows until the electrical charges are supplied to the smoothing capacitor C2. Thereby, the circuit device of the switching power supply apparatus 1, which is included in the bridgeless power factor correction circuit 104 and the like, is protected from the inrush current.

The main converter 108 is arranged on a power feed path from the bridgeless power factor correction circuit 104 to the load circuit 109. The direct current power output from the bridgeless power factor correction circuit 104 is input to the main converter 108. The main converter 108 converts the voltage of the input direct current power and outputs the converted direct current voltage to the load circuit 109 from the output terminal 112. In the meantime, the main converter 108 may convert direct current power to alternating current power.

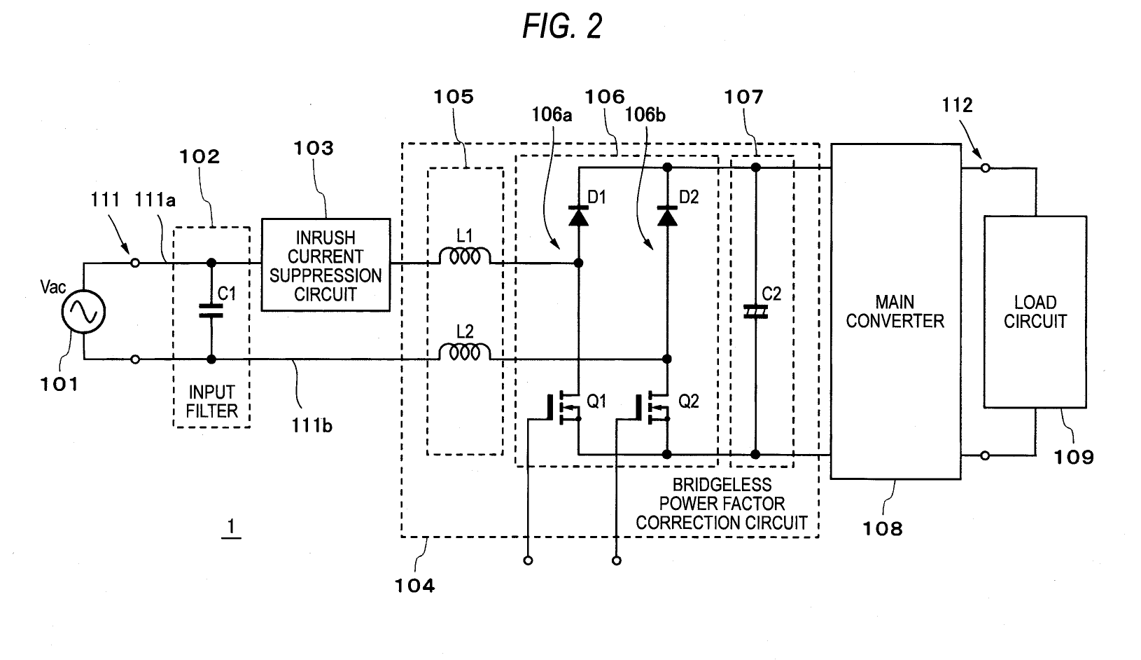

FIG. 2 is a circuit diagram illustrating a detailed configuration of the switching power supply apparatus 1.

Referring to FIG. 2, the switching circuit 106 has a first series circuit 106a and a second series circuit 106b.

The first series circuit 106a has a first field effect transistor (which is an example of a first switching device) Q1 and a first diode (which is an example of a first rectification device) D1. A drain (which is an example of an output terminal of the first switching device) of the field effect transistor Q1 is connected to an anode of the diode D1. The field effect transistor Q1 and the diode D1 are arranged in series with each other.

The second series circuit 106b has a second field effect transistor (which is an example of a second switching device) Q2 and a second diode (which is an example of a second rectification device) D2. A drain (which is an example of an output terminal of the second switching device) of the field effect transistor Q2 is connected to an anode of the diode D2.

Cathodes of the diodes D1, D2 are connected to each other and sources of the field effect transistors Q1, Q2 are connected to each other. That is, the second series circuit 106b is connected in parallel with the first series circuit 106a.

One end of the first inductor L1 is connected to a connection point of the field effect transistor Q1 and the diode D1. The other end of the first inductor L1 is connected to the inrush current suppression circuit 103. That is, the connection point of the field effect transistor Q1 and the diode D1 is connected to the first line 111a through the first inductor L1 and the inrush current suppression circuit 103.

One end of the second inductor L2 is connected to a connection point of the field effect transistor Q2 and the diode D2. The other end of the second inductor L2 is connected to the input terminal 111. That is, the connection point of the field effect transistor Q2 and the diode D2 is connected to the second line 111b through the second inductor L2.

The bridgeless power factor correction circuit 104 turns on/off the current flowing in the two inductors L1, L2 with a predetermined frequency by the switching circuit 106. The current may be turned on/off by controlling voltages of gate terminals of the field effect transistors Q1, Q2. Thereby, the energies that are accumulated in each of the two inductors L1, L2 when the current becomes on are taken out by the diodes D1, D2 when the current becomes off, as counter-electromotive force. Thereby, it is possible to take out an output voltage higher than the alternating current voltage Vac and to rectify the alternating current, thereby outputting the direct current.

### [Description of Inrush Current Suppression Circuit 103]

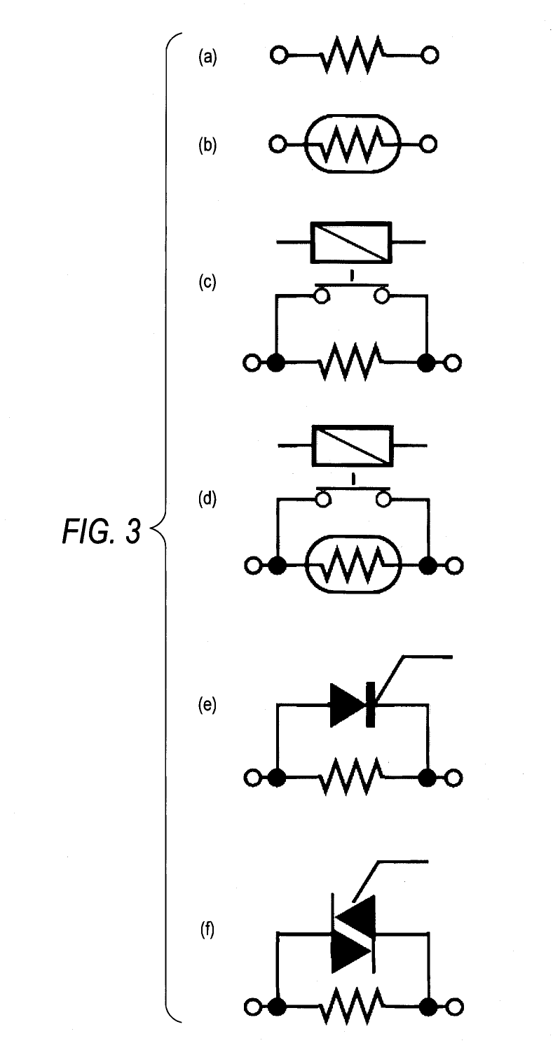

FIG. 3 illustrates an example of a configuration of the inrush current suppression circuit 103.

FIG. 3 includes examples (a) to (f). FIGS. 3(a) to 3(f) respectively show examples of the configuration of the inrush current suppression circuit 103. Any one of FIGS. 3(a) to 3(f) may be used as the inrush current suppression circuit 103. In the meantime, the configuration of the inrush current suppression circuit 103 is not limited to FIGS. 3(a) to 3(f) and the inrush current suppression circuit 103 may have the other configuration.

As shown in an example (a) of FIG. 3, the inrush current suppression circuit 103 may be configured by a resistance, for example.

As shown in an example (b) of FIG. 3, the inrush current suppression circuit 103 may be configured by a thermistor, for example.

As shown in an example (c) of FIG. 3, the inrush current suppression circuit 103 may be configured by a resistance and a relay connected in parallel with the resistance, for example.

As shown in an example (d) of FIG. 3, the inrush current suppression circuit 103 may be configured by a thermistor and a relay connected in parallel with the thermistor, for example.

As shown in an example (e) of FIG. 3, the inrush current suppression circuit 103 may be configured by a resistance and a thyristor connected in parallel with the resistance, for example.

As shown in an example (f) of FIG. 3, the inrush current suppression circuit 103 may be configured by a resistance and a triac connected in parallel with the resistance, for example.

### Effects of Illustrative Embodiment

As described above, in this illustrative embodiment, since the switching power supply apparatus 1 has the bridgeless power factor correction circuit 104 that does not include a bridge diode for rectification, it is possible to realize the higher power conversion efficiency. Also, the switching power supply apparatus 1 is provided with the inrush current suppression circuit 103. Therefore, when the supply of the alternating current voltage Vac starts, the inrush current that flows so as to supply the electrical charges to the smoothing capacitor C2 is suppressed. Thus, the countermeasure against the inrush current is effectively performed in the circuit device of the switching power supply apparatus 1, so that the reliability of the switching power supply apparatus 1 is increased.

Also, since the inrush current suppression circuit 103 is arranged on the first line 111a connecting the end of the line capacitor C1 and the first inductor L1, the current that is caused because the line capacitor C1 is arranged between the first line 111a and the second line 111b does not flow in the inrush current suppression circuit 103. Since the reactive power does not flow in the inrush current suppression circuit 103, the power loss is suppressed. Accordingly, it is possible to lower the useless power consumption of the switching power supply apparatus 1, including the standby power consumption.

### Modified Embodiments to Arrangement of Inrush Current Suppression Circuit 103

The arranging position of the inrush current suppression circuit 103 is not limited to the position of the illustrative embodiment. Also, the number of the inrush current suppression circuit 103 is not limited to one. That is, the inrush current suppression circuit 103 may be arranged on at least one or more paths of the second line 111b of the two paths connecting between the ends of the line capacitor C1 and the boost inductor unit 105, the paths between the boost inductor unit 105 and the switching circuit 106 and the paths between the switching circuit 106 and the smoothing capacitor C2, i.e., the smoothing unit 107.

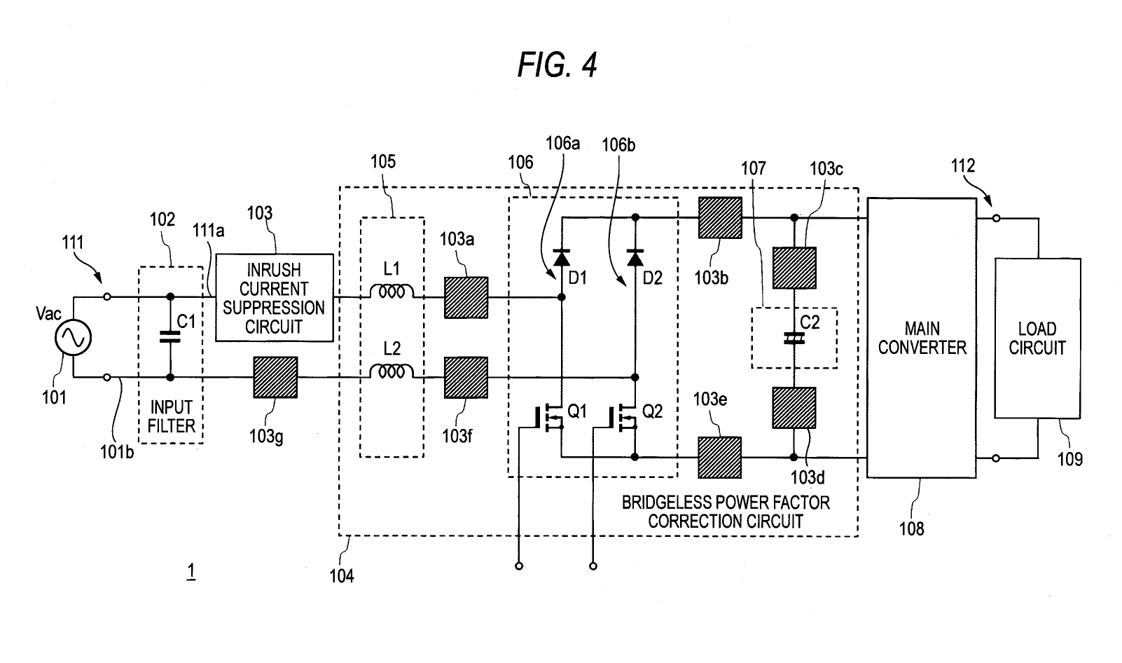

FIG. 4 is a circuit diagram illustrating a modified embodiment of the illustrative embodiment.

Referring to FIG. 4, the inrush current suppression circuit 103 may be arranged at each of positions 103a to 103g shown in FIG. 4.

That is, the inrush current suppression circuit 103 may be arranged on a path 103g connecting between the end of the line capacitor C1 and the second inductor L2.

The inrush current suppression circuit 103 may be arranged on a path 103a connecting between the first inductor L1 and the first series circuit 106a. The inrush current suppression circuit 103 may be arranged on a path 103f connecting between the second inductor L2 and the second series circuit 106b.

The inrush current suppression circuit 103 may be arranged at positions 103b, 103e, which are closer to the switching circuit 106 than the position at which the smoothing capacitor C2 is connected, on each of the two output lines connected from the switching circuit 106 to the output terminal 112 through the main converter 108.

The inrush current suppression circuit 103 may be arranged on paths 103c, 103d connecting the ends of the smoothing capacitor C2 to each of the two output lines connected from the switching circuit 106 to the output terminal 112 through the main converter 108.

Like this, even when the inrush current suppression circuit 103 is arranged at any position, the inrush current suppression circuit 103 can realize the purpose of suppressing the inrush current to the smoothing capacitor C2 having a large capacity value. Also, the reactive power does not flow in the inrush current suppression circuit 103 by a combination with the line capacitor C1 that is used in the input filter 102 for the power factor correction circuit, so that it is possible to suppress the occurrence of the power loss. It is possible to appropriately select the position at which the inrush current suppression circuit 103 is arranged, taking into consideration the design conditions and the like of the switching power supply apparatus 1 and to arrange the inrush current suppression circuit 103 at the plurality of positions.

### [Others]

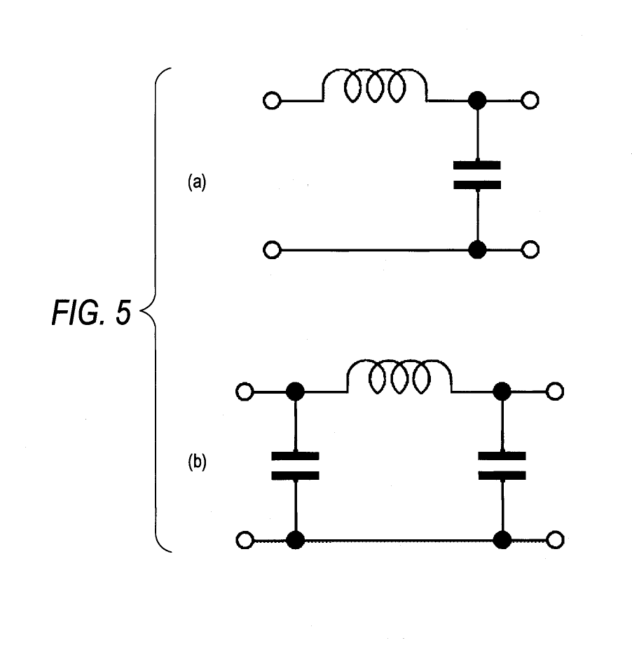

FIG. 5 illustrates an example of a configuration of the input filter provided for the power factor correction circuit.

FIG. 5 includes examples (a) and (b). FIGS. 5(a) and 5(b) illustrate examples of the configuration of the input filter. In the switching power supply apparatus, any one of the input filters shown in FIGS. 5(a) and 5(b) may be used instead of the input filter 102 of the above illustrative embodiment. In the meantime, the configuration of the input filter is not limited thereto and the other configurations are also possible.

As shown in an example (a) of FIG. 5, the input filter may have a configuration having an inductor that is arranged on one line of two lines through which the alternating current power is fed and a capacitor that is arranged between the two lines.

As shown in an example (b) of FIG. 5, the input filter may have a configuration having an inductor that is arranged on one line of two lines through which the alternating current power is fed and two capacitors that are arranged at both end sides of the inductor between the two lines, like a so-called π-type filter.

In the switching power supply apparatus, the main converter may not be arranged. The switching power supply apparatus may have a sub-converter in addition to the main converter. As the sub-converter, a standby converter for generating standby power may be used, for example. The sub-converter may be arranged at both ends of the smoothing capacitor C2 on paths branched from the paths to the main converter.

In the meantime, in the switching power supply apparatus having the bridgeless power factor correction circuit, a noise filter such as EMI filter may be arranged to suppress a noise from being leaked or introduced through a wiring, taking into consideration the design conditions and the like. In general, regarding the line capacitor that is used in the noise filter, a capacitor is used which has a relatively small capacity value to the capacity value of the line capacitor that is used in the input filter provided for the power factor correction circuit.

The configuration of the bridgeless power factor correction circuit is not limited to the above. This disclosure can be widely applied to a switching power supply apparatus having a bridgeless power factor correction circuit that does not include a bridge diode for rectification.

The illustrative embodiments are just exemplary and should not be construed to limit this disclosure. The scope of this disclosure is indicated by the claims and includes all modifications and equivalents.

What is claimed is:

1. A switching power supply apparatus comprising:
an input part, which is configured to connect to an alternating current power supply;
an input filter provided for a power factor correction circuit, which includes at least a line capacitor connected to the input part in parallel with the alternating current power supply;
a bridgeless power factor correction circuit that is connected to the input part at a position more distant from the alternating current power supply than the input filter; and
an inrush current suppression circuit to suppress inrush current,
wherein the bridgeless power factor correction circuit comprises:
a conversion unit, which has a boost inductor unit to which alternating current from the input part is input and a switching circuit connected to the boost inductor unit, which rectifies an alternating current voltage input from the alternating current power supply and performs a power factor improvement operation, and which outputs a boosted ripple voltage; and
a smoothing unit that is connected to an output terminal side of the conversion unit and smoothes the ripple voltage output from the conversion unit, and
wherein the inrush current suppression circuit is arranged at least one of:
a path connecting between an end of the input filter and the boost inductor unit;
a path connecting between the boost inductor unit and the switching circuit; and
a path connecting between the switching circuit and the smoothing unit.

2. The switching power supply apparatus according to claim 1,
wherein the inrush current suppression circuit is arranged on the path connecting an end of the input filter and the boost inductor unit,
wherein the switching circuit comprises:
a first series circuit including a first switching device and a first rectification device connected to an output terminal of the first switching device, and
a second series circuit including a second switching device and a second rectification device connected to an output terminal of the second switching device,
wherein the second series circuit is connected in parallel with the first series circuit,
wherein the smoothing unit has a smoothing capacitor that is connected to an output terminal of the switching circuit in parallel with the switching circuit, and
wherein the boost inductor unit comprises:
a first inductor, of which one end is connected to a connection point of the first switching device and the first rectification device and the other end connected to the inrush current suppression circuit, and
a second inductor, of which one end is connected to a connection point of the second switching device and the second rectification device and the other end connected to the input part.
